(19) United States
(12) Patent Application Publication
(10) Pub. No.: US 2014/0056552 A1
(43) Pub. Date: Feb. 27, 2014

(54) OPTICAL PATH ROUTING ELEMENT

(71) Applicant: Oki Electric Industry Co., Ltd., Tokyo (JP)

(72) Inventor: Hideaki OKAYAMA, Tokyo (JP)

(73) Assignee: OKI ELECTRIC INDUSTRY CO., LTD., Tokyo (JP)

(21) Appl. No.: 13/971,248

(22) Filed: Aug. 20, 2013

(30) Foreign Application Priority Data
Aug. 21, 2012 (JP) 2012-182037

(51) Int. Cl. G02B 6/27

(52) U.S. Cl. CPC G02B 6/27
USPC 385/11

(57) ABSTRACT

An optical path routing element includes first and second optical waveguide that are parallel to each other. The first and second waveguides have the same thickness and have the same width, the width being larger than the thickness. The width is within a range based upon coupling lengths of the first and second waveguides for a TE polarization and for a TM polarization such that the difference between the coupling length for TE polarization and the coupling length for TM polarization is no more than a predetermined percentage times the sum of the coupling length for TE polarization and the coupling length for TM polarization divided by 2.

### CROSS-REFERENCE TO RELATED APPLICATION

This application claims priority under 35 U.S.C. §119 from Japanese Patent Application No. P 2012-182037, filed on Aug. 21, 2012, the disclosure of which is incorporated herein by reference.

### BACKGROUND OF THE INVENTION

1. Field of the Invention

This application relates to the art of optical path routing elements that route optical paths based on differences in wavelength.

2. Description of Related Art

The U.S. Pat. No. 4,860,294 B2 to Winzer, et al., U.S. Pat. No. 5,764,826 B2 to Kuhara, et al., U.S. Pat. No. 5,960,135 B2 to Ozawa, et al., U.S. Pat. No. 7,072,541 B2 to Kim, et al., Japanese patent laid-open publication No. 1996-163028, and Japanese patent laid-open publication No. 2004-157192 describe an optical waveguide element. The optical waveguide element is made with, for example, silicon (Si), and is exceedingly small. And more, processes to fabricate the CMOS (Complementary Metal Oxide Semiconductor) are utilized to fabricate the optical waveguide element, so the costs to make the optical waveguide element may be constrained.

A silicon nanowire waveguide has the structure where a silicon waveguide (core) is surrounded by a material, such as silicon oxide (SiO2), having a refractive index smaller than that of silicon. The refractive index of the silicon oxide forming the cladding layer is very different from the refractive index of the silicon forming the core. So, it is possible to confine almost all of optical electric field components within the core and hence to reduce the cross-sectional dimension of the core to a quite small size, for example, a diameter on the order of submicrons. Furthermore, the silicon nanowire waveguide can be made by using common processes for fabricating semiconductor devices or chips and thus be easily mass-produced. The optical path routing element may be constituted by the silicon waveguide.

Japanese Unexamined Patent Application Publication No. 2007-523387 and the publication in the journal “IEICE Trans. Electron,” at vol. E90-C, No. 1, p. 59-64 (January 2007) describe a silicon waveguide that includes gratings. The function of the wavelength filter is used by a Mach-Zehnder interferometer, a directional coupler, and a grating. Optical wavelength filters using gratings of high reflection efficiency can provide a fixed transmittance in the passband.

When the optical path routing element is constituted by a silicon waveguide, a grating may be used generally to achieve the function of the path routing element. However, there is a necessity to fabricate the grating having a much shorter period than the wavelength of the optical carrier wave of optical signals whose path will be switched by the path-routing element including the grating.

And more, when an optical directional coupler is used to achieve the function of the path routing element instead of a grating, there is a necessity to fabricate the optical directional coupler with adequate dimensional precision to achieve polarization independence by using the waveguide. If the optical directional coupler works with polarization independence, the coupling length to the TE (Transverse Electric) polarization equals the coupling length to the TM (Transverse Magnetic) polarization. The coupling length is the length needed to transfer optical power from one waveguide to another waveguide.

If the difference in coupling length between the TE polarization and TM polarization might be more than 6%, which is an acceptable value to use actually, the extinction ratio cannot be restrained to within −20 (dB). Thus, if the optical directional coupler works with the polarization independence, the difference in coupling length between the TE polarization and TM polarization will need to be less than 6%. A 6% difference of the coupling length means that |LTE−LTM|/L0=0.06 (6%), where LTE means the coupling length to TE polarization, and LTM means the coupling length to the TM polarization. L0 means the average of the LTE and LTM.

### SUMMARY OF THE DISCLOSURE

An optical path routing element capable of working with the polarization independence, and thicknesses and widths of optical waveguides, wherein a center interval between centers of the optical waveguides is within acceptable errors is disclosed.

According to one aspect, an optical path routing element includes first and second optical waveguides that are parallel to each other. The first and second waveguides have the same thickness and have the same width, the width being larger than the thickness. The width is within a range based upon coupling lengths of the first and second waveguides for a TE polarization and for a TM polarization such that the difference between the coupling length for TE polarization and the coupling length for TM polarization is no more than a predetermined percentage times the sum of the coupling length for TE polarization and the coupling length for TM polarization divided by 2.

### BRIEF DESCRIPTION OF THE DRAWINGS

The optical path routing element will be more fully understood from the following detailed description with reference to the accompanying drawings, which is given by way of illustration only, and is not intended to limit the scope of the invention, wherein:

FIG. 1 is a schematic perspective view that illustrates the composition of the optical path routing element; and

FIGS. 2-5 illustrate different relationships between the widths of the optical waveguides and the coupling length.

### DETAILED DESCRIPTION OF THE INVENTION

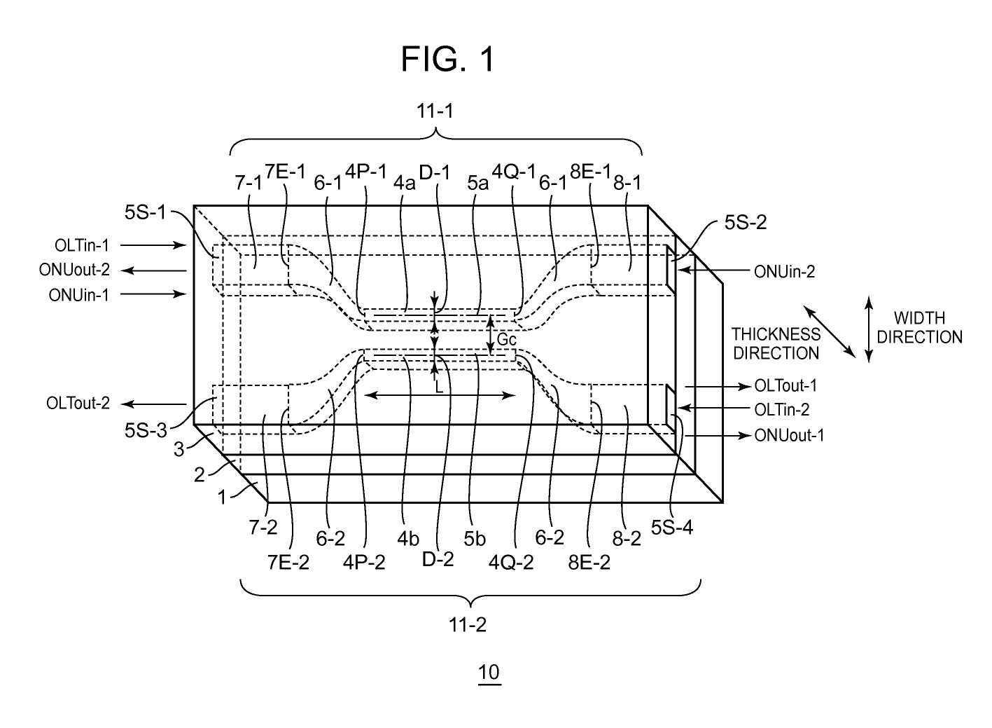

The optical path routing element will be described with reference to FIGS. 1 to 5 of the drawings, in which like elements are indicated by like reference characters. In the drawings, configurations, positional relations, dimensions, and alignments of elements of the device are illustrated generally for understanding the embodiment and are only intended to provide an understanding of the invention. Described materials and numerical values are merely exemplary. In the drawings, common elements of structures may be designated by the same reference characters, and an explanation thereof is occasionally omitted. Accordingly, the invention is in no way limited to the following embodiment.

### Configuration

The structure of the optical path routing element 10 in FIG. 1 may include structures 11-1 and 11-2. The structure 11-1 may include a linear first optical waveguide 4a of uniform width, a linear input optical waveguide 7-1 of uniform width, a linear output optical waveguide 8-1 of uniform width, and a curved optical waveguide 6-1 of nonuniform width, all on a silicon substrate 1. The structure 11-2 may include on a silicon substrate 1 a linear first optical waveguide 4b of uniform width, a linear input optical waveguide 7-2, a linear output optical waveguide 8-2 of uniform width, and a curved optical waveguide 6-2 of nonuniform width. The structure 11-1 and the structure 11-2 may be line-symmetric.

Thus, referring to the FIG. 1, there are two curved optical waveguides 6-1. One of them is connected to the input optical waveguide 7-1. The other is connected to the output optical waveguide 8-1. The two curved optical waveguides 6-1 may have the same function. The curved optical waveguides 6-1 and 6-2 may have the same shape, the input optical waveguides 7-1 and 7-2 may have the same shape, and the output optical waveguides 8-1 and 8-2 may also have the same shape.

The first optical waveguide 4a and the second optical waveguide 4b are provided on the lower cladding 2 that is formed on the silicon substrate 1. The first optical waveguide 4a is parallel to the second optical waveguide 4b, and a predetermined uniform distance is provided between them. The first optical waveguide 4a and the second optical waveguide 4b define as the directional coupler. A “length” of the directional coupler may be designated “L” (FIG. 1), which is the coupling length.

One side of the first optical waveguide 4a is connected to the input optical waveguide 7-1 via the curved optical waveguide 6-1, and the other side of the first optical waveguide 4a is connected to the output optical waveguide 8-1 via the curved optical waveguide 6-1. One side of the second optical waveguide 4b is connected to the input optical waveguide 7-2 via the curved optical waveguide 6-2, and the other side of the second optical waveguide 4b is connected to the output optical waveguide 8-2 via the curved optical waveguide 6-2.

The center interval between the center axes of the input optical waveguides 7-1 and 7-2 may be designed so as to eliminate the coupling of optical signal propagated through these waveguides. And, the center interval between the center axes of the output optical waveguides 8-1 and 8-2 may be also designed so as to eliminate the coupling of optical signal propagated through the input optical waveguides 7-1 and 7-2.

The first optical waveguide 4a, the second optical waveguide 4b, the input optical waveguides 7-1 and 7-2, curved optical waveguides 6-1 and 6-2, and the output optical waveguides 8-1 and 8-2 all include cores embedded by a lower cladding 2 and an upper cladding 3.

Referring to FIG. 1 and treating the optical path routing element 10 as being disposed vertically for convenience of explanation only, a planar surface 5S-1 closing a lower end of the input optical waveguide 7-1 extends perpendicularly to that waveguide's center axis, a planar surface 5S-2 closing an upper end of the output optical waveguide 8-1 extends perpendicularly to that waveguide's center axis, and similar planar cladding 5S-3 and 5S-4 are provided respectively at the lower end of the input optical waveguide 7-2 and the output optical waveguide 8-2.

The input optical waveguides 7-1 and 7-2 may propagate input optical signals, and the output optical waveguides 8-1 and 8-2 may propagate output optical signals. However, the input optical waveguides 7-1 and 7-2 and the output optical waveguides 8-1 and 8-2 described herein are not limited to any particular configuration. For example, the input optical waveguides 7-1 and 7-2 may propagate output optical signals, and the output optical waveguides 8-1 and 8-2 may propagate input optical signals.

One of the curved optical waveguides 6-1 is connected to the input optical waveguide 7-1 and the first optical waveguide 4a at edges 7E-1 and 4P-1, respectively. The width of the curved optical waveguide 6-1 at the edge 7E-1 may be equal to the width of the input optical waveguide 7-1, and the width of the curved optical waveguide 6-1 at the edge 4P-1 may be equal to the width D-1 of the first optical waveguide 4a.

The other curved optical waveguides 6-1 and 6-2 are similarly arranged. That is, the other curved optical waveguide 6-1 is connected to the output optical waveguide 8-1 and the first optical waveguide 4a at an edges 8E-1 and 4Q-1, respectively. And the width of the curved optical waveguide 6-1 at the edge 8E-1 may be equal to the width of the output optical waveguide 8-1, and the width of the curved optical waveguide 6-1 at the edge 4Q-1 may be equal to the width D-1 of the first optical waveguide 4a.

Likewise, one of the curved optical waveguides 6-2 is connected to the input optical waveguide 7-2 and the second optical waveguide 4b at an edges 7E-2 and 4P-2, respectively. And the width of the curved optical waveguide 6-2 at the edge 7E-2 may be equal to the width of the input optical waveguide 7-2, and the width of the curved optical waveguide 6-2 at the edge 4P-2 may be equal to the width D-2 of the second optical waveguide 4b.

And likewise, the other curved optical waveguide 6-2 is connected to the output optical waveguide 8-2 and the second optical waveguide 4b at edges 8E-2 and 4Q-2, respectively. And the width of the curved optical waveguide 6-2 at the edge 8E-2 may be equal to the width of the output optical waveguide 8-2, and the width of the curved optical waveguide 6-2 at the edge 4Q-2 may be equal to the width D-2 of the second optical waveguide 4b.

The curved optical waveguides 6-1 and 6-2 may curtail radiation loss to be extreme low at parts of the curved waveguides, and a polarization independence may be achieved as a result of a simulation testing. More details are described below.

Referring to FIG. 1, a center interval Gc is the distance between a center axis 5a of the first optical waveguide 4a and a center axis 5b of the second optical waveguide 4b. The first optical waveguide 4a and the second optical waveguide 4b are formed parallel to each other at a distance L.

The width D-1 of the first optical waveguide 4a and the width D-2 of the second optical waveguide 4b may be set so that the optical signals of the first wavelength and the second wavelength could be a single mode. And more, the width D-1 and the width D-2 may be set so as to provide an equal effective guide index between the first optical waveguide 4a and the second optical waveguide 4b. The antisymmetric mode is a propagating mode in which antisymmetrically coupling optical signals in a space amplitude distribution of an optical electric field may propagate. The distance (to be the previously mentioned coupling length) L and the interval of the Gc may be set so that optical signals of the first wavelength may transfer from the first optical waveguide 4a to the second optical waveguide 4b.

### Processing of the Optical Path Routing Element 10

The input optical waveguide 7-1 may receive the optical signals of the first wavelength and the second wavelength, and a route of the signals of the first wavelength may be switched from the first optical waveguide 4a to the second optical waveguide 4b. Therefore, the optical signals of the first wavelength are output from the output optical waveguide 8-2. A route of the second wavelength may not be switched, so the optical signals of the second wavelength are output from the output optical waveguide 8-1.

For example, the ONU (Optical Network Unit) and the OLT (Optical Line Terminal) in the PON (Passive Optical Network) system may include the optical path routing elements 10. The wavelength bands of the upstream signals may be set at 1.31 μm in the PON system, and the wavelength bands of the downstream signals may be set at 1.49 μm. Thus, the first wavelength may be set at 1.49 μm, and the second wavelength may be set at 1.31 μm.

When the OLT includes the optical path routing element 10, the downstream signals from a light emitting device (not shown) in the OLT may be input to the port 5S-1 (FIG. 1, OLTin-1), and then the downstream signals may be output from the port 5S-4 (OLTout-1). And, the upstream signals may be input to the port 5S-4 (OLTin-2), and then the upstream signals may be output from the port 5S-3 (OLTout-2). After outputting the upstream signals from the port 5S-3, the upstream signals may be detected by a light receiving element (not shown).

When the ONU(s) include(s) the optical path routing element 10, the upstream signals from a light emitting device (not shown) in the ONU(s) may be input to the port 5S-2 (FIG. 1, ONUin-2), and then the upstream signals may be output from the port 5S-1 (ONUout-2). And, the downstream signals may be input to the port 5S-1 (ONUin-2), and then the downstream signals may be output from the port 5S-4 (ONUout-1). After outputting the downstream signals from the port 5S-4, the downstream signals may be detected by a light receiving element (not shown).

### Manufacturing Optical Path Routing Element 10

When the optical path routing element 10 is manufactured, a Silicon On Insulator (SOI) substrate is preferably used. The SOI substrate includes a SiO₂ layer on a silicon substrate 1, and the SOI substrate includes a silicon layer on the SiO₂ layer. The thickness of the silicon layer may be equal to the thickness of an optical waveguide.

A method of manufacturing the SOI substrate is that firstly, a SiO₂ layer is formed on a silicon substrate 1, and secondly, a silicon layer is formed on the SiO₂ layer. And manufacturing the optical path routing element 10 may include firstly, forming the silicon layer in the SOI substrate by patterning the first optical waveguide 4a, the second optical waveguide 4b, the curved optical waveguides 6, the input optical waveguides 7, and the output optical waveguides 8 for example, by dry etching, and then secondly, fabricating an upper cladding 3 corresponding to the SiO₂ layer by depositing a layer of cladding material such as an SiO₂ layer, for example, by CVD (Chemical Vapor Deposition) on the silicon layer.

As a result of the preceding manufacturing method, the optical path routing element 10 is manufactured. The optical path routing element 10 includes the first optical waveguide 4a, the second optical waveguide 4b, the curved optical waveguides 6-1 and 6-2, the input optical waveguides 7-1 and 7-2, and the output optical waveguides 8-1 and 8-2 on the silicon substrate 1.

### Result of Simulation

The index of refraction for the first optical waveguide 4a, the second optical waveguide 4b, the curved optical waveguides 6-1 and 6-2, the input optical waveguides 7-1 and 7-2, and the output optical waveguides 8-1 and 8-2 may be 3.5 in each simulation, and the index of refraction for the lower cladding 2 and the upper cladding 3 may be 1.46. The wavelength may be 1490 nm.

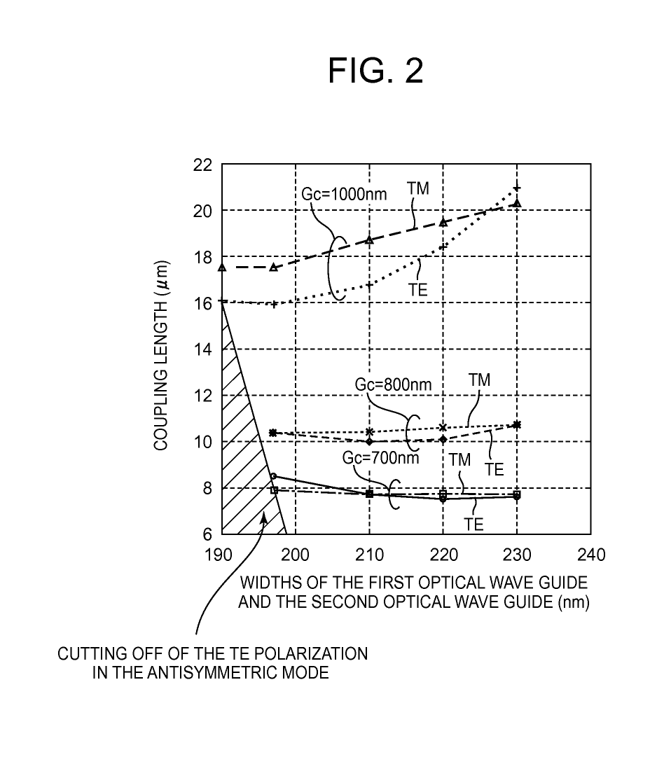

Referring to the FIG. 2, values along the vertical axis correspond to the coupling length, and values along the horizontal axis correspond to the width D-1 and the width D-2. The interval Gc may be 700 nm, 800 nm, or 1000 nm, and a method of the simulation may be the 3D FDTD (Finite Difference Time Domain).

The simulation (FIG. 2) proceeds when the thicknesses of the first optical waveguide 4a and the second optical waveguide 4b are 220 nm. A triangle area (FIG. 2) indicates a range of the TE polarization in the antisymmetric mode that is cut off. In the description of the simulation in optical path routing element 10, the interval Gc may be 700 nm, 800 nm, or 1000 nm. However, the optical path routing element 10 described herein is not limited to any particular element. For example, the interval Gc may adopt various values for example, 600 nm, 750 nm, or within a range such as 600 nm to 700 nm.

From FIG. 2, the conditions of the TE polarization in the antisymmetric mode that is cut off may be determined. The conditions of the TM polarization in the antisymmetric mode that is cut off may be discovered to be milder than the conditions of the TE wave in the antisymmetric mode that is cut off. And, if the TE polarization in the antisymmetric mode is not cut off, the TM polarization in the antisymmetric mode may be found to be not cut off. Thus, a range of the interval Gc may be determined under the conditions of the TE polarization in the antisymmetric mode that is not cut off.

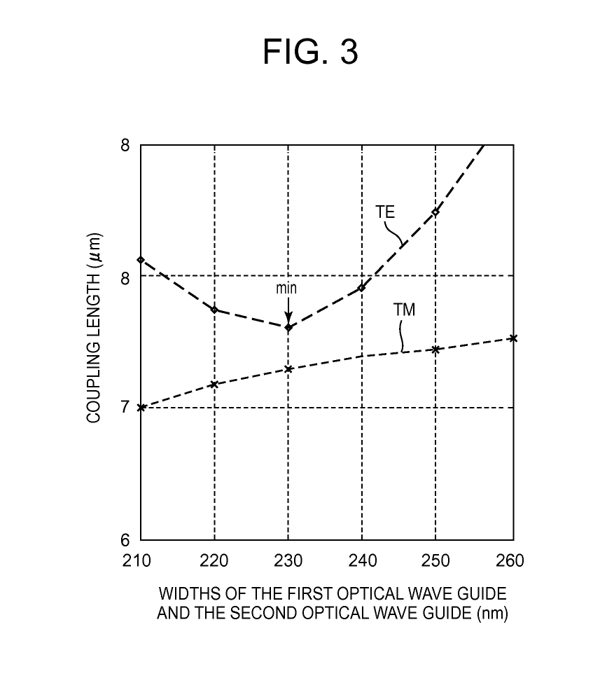

Referring to the FIG. 3 to FIG. 5, results of a simulation of relationships between the widths D-1 and D-2 and the coupling length are described. FIG. 3 to FIG. 5 describe values along the horizontal axis corresponding to the widths D-1 and D-2 (nm), and values along the vertical axis corresponding to the coupling length (μtm).

Firstly, referring to FIG. 3, a result of simulation under the condition that the interval Gc is 700 nm is described below. In this simulation, the thicknesses of first optical waveguide 4a and the second optical waveguide 4b are 210 nm.

From this result of simulation, it can be seen that a degree of affect (e.g. percentage affect) upon the coupling length (FIG. 3, TE) by a variation of the widths D-1 and D-2 may be higher than a degree of affect (e.g. percentage affect) the coupling length (FIG. 3, TM) by a variation of the widths D-1 and D-2, and the coupling length (FIG. 3, TE) has a minimal value (FIG. 3, min). There may be a minimal value (min), when the widths D-1 and D-2 are equal to 230 nm in FIG. 3.

The difference between coupling lengths (TE, TM) may be approximately 4.6% when the widths D-1 and D-2 are 230 nm. If a percentage difference between coupling lengths is more than 6%, the extinction ratio cannot be curtailed to within −20 (dB). As a result of the simulation, it is seen that ranges of the widths D-1, D-2 that are less than 6% in a difference between coupling lengths may be from 225 nm to 235 nm. Thus, the widths D-1 and D-2 may be permitted a margin of error of 10 nm (235 nm-225 nm) when the widths D-1 and D-2 are produced.

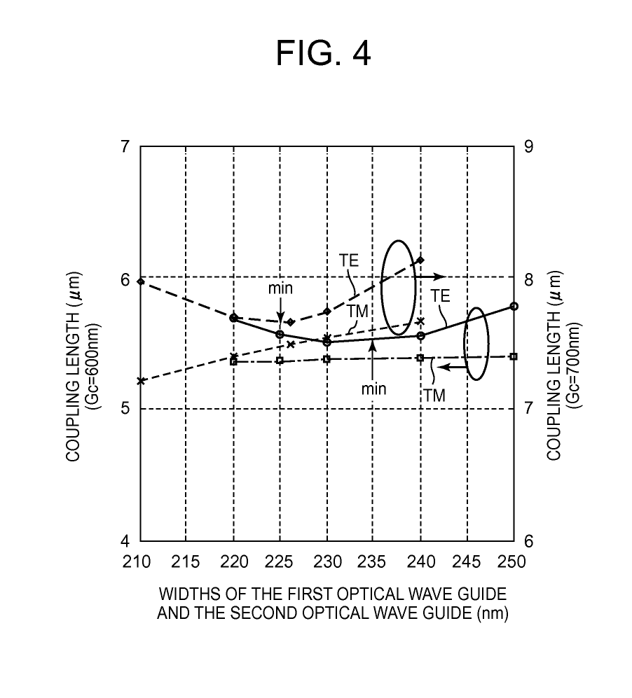

Secondly, referring to FIG. 4, a result of simulation under the condition that the interval Gc is 600 nm and 700 nm is described below. In this simulation, the thicknesses of first optical waveguide 4a and the second optical waveguide 4b are 220 nm. The values along the vertical axis on the left side correspond to the coupling length (μm) when the interval Gc is 600 nm, and the values along the vertical axis on the right side correspond to the coupling length (μm) when the interval Gc is 700 nm. From this simulation result, it can be seen that a degree of affect (e.g. percentage affect) upon the coupling length (FIG. 4, TE) by a variation of the widths D-1 and D-2 may be higher than a degree of affect (e.g. percentage affect) upon the coupling length (FIG. 4, TM) by a variation of the widths D-1 and D-2, and the coupling length (FIG. 4, TE) has a minimal value (FIG. 4, min-1, min-2).

The minimal value may be 235 nm (FIG. 4, min-1) when the interval Gc is 600 nm, and the minimal value may be 225 nm (FIG. 4, min-2) when the interval Gc is 700 nm. The difference between coupling lengths (TE, TM) may be approximately 3.1% when the widths D-1 and D-2 are 235 nm, and the difference between coupling lengths (TE, TM) may be approximately 2.6% when the widths D-1 and D-2 are 225 nm. As a result of the simulation, it can be seen that when the interval Gc is 600 nm, ranges of the widths D-1 and D-2 that are less than 6% in a difference between coupling lengths may be from 220 nm to 250 nm. Thus, the widths D-1 and D-2 may be permitted a margin of error of 30 nm (250 nm-220 nm) when the widths D-1 and D-2 are produced. And more, when the interval Gc is 700 nm, ranges of the widths D-1 and D-2 that are less than 6% in a difference between coupling lengths may be from 210 nm to 240 nm. Thus, the widths D-1 and D-2 may be permitted a margin of error of 30 nm (240 nm-210 nm) when the widths D-1 and D-2 are produced.

When the simulation in FIG. 4 is compared with simulation in FIG. 3, the value (30 nm) of the margin of error in FIG. 4 may be 2.5 times more than the value (10 nm) of the margin of error in FIG. 3.

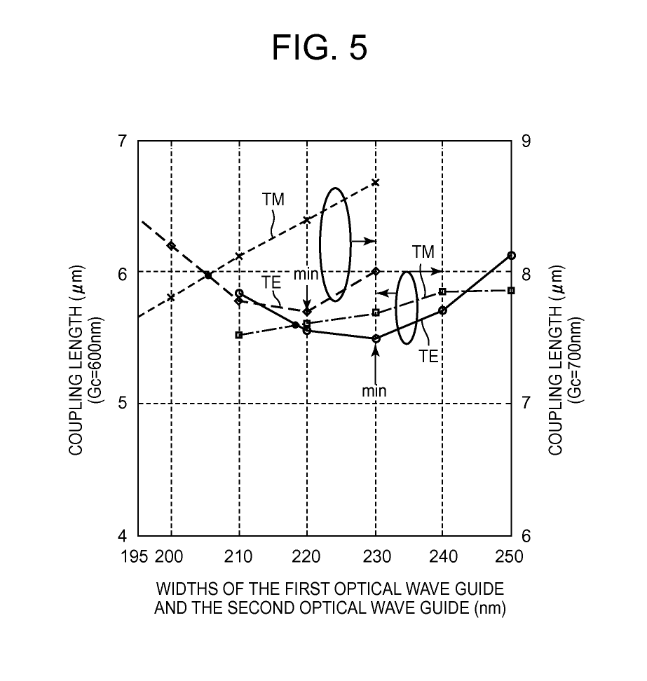

Thirdly, referring to FIG. 5, a result of simulation under the condition that the interval Gc is 600 nm and 700 nm is described below. The values along the vertical axis on the left side correspond to the coupling length (μm) when the interval Gc is 600 nm, and the values along the vertical axis on the right side correspond to the coupling length (μm) when the interval Gc is 700 nm.

The coupling length (FIG. 5, TE) has a minimal value (FIG. 5, min-1, min-2), and the coupling length (FIG. 5, TE) and the coupling length (FIG. 5, TM) are crossed (FIG. 5, dot-1, dot-2). The minimal value may be 230 nm (FIG. 5, min-1) when the interval Gc is 600 nm, and the minimal value may be 220 nm (FIG. 5, min-2) when the interval Gc is 700 nm.

As a result of the simulation, when the interval Gc is 600 nm, ranges of the widths D-1 and D-2 that are less than 6% in a difference between coupling lengths may be from 210 nm to 250 nm, and the widths D-1 and D-2 may be permitted a margin of error of 40 nm when the widths D-1 and D-2 are produced. And more, when the interval Gc is 700 nm, ranges of the widths D-1 and D-2 that are less than 6% in a difference between coupling lengths may be from 195 nm to 230 nm, and the widths D-1 and D-2 may be permitted a margin of error of 35 nm (230 nm-195 nm) when the widths D-1 and D-2 are produced. The dot-1 and dot-2 indicate that the coupling length (FIG. 5, TE) is equal to the coupling length (FIG. 5, TD).

When the simulation in FIG. 5 (Gc=600 nm) is compared with simulation in FIG. 4 (Gc=600 nm), the value (40 nm) of the margin of error in FIG. 5 may be more than 1.3 times the value (30 nm) of the margin of error in FIG. 4. But, when the simulation in FIG. 5 (Gc=700 nm) is compared with simulation in FIG. 4 (Gc=700 nm), the value (20 nm) of the margin of error in FIG. 5 may be more than 0.8 times the value (25 nm) of the margin of error in FIG. 4.

When the interval Gc is 700 nm, the achievement of polarization independence requires that ranges of the widths D-1 and D-2 are around the dot-2 (FIG. 5) rather than the min-2 (FIG. 5). Around the dot-2, the thicknesses of first optical waveguide 4a and the second optical waveguide 4b are shorter than the widths D-1 and D-2.

If the thicknesses of first optical waveguide 4a and the second optical waveguide 4b are greater than 240 nm, the achievement of polarization independence may be at only the dot-1 (FIG. 5). In addition to the above, the thicknesses of the first optical waveguide 4a and the second optical waveguide 4b may need to be less than the widths D-1 and D-2.

Meanwhile, if the thicknesses of the first optical waveguide 4a and the second optical waveguide 4b are in the range of 210 nm to 240 nm, the coupling length (FIG. 5, TE) has a minimal value (FIG. 5, min-1, min-2). Thus, the widths D-1 and D-2 may be permitted a larger margin of error than when the thicknesses of first optical waveguide 4a and the second optical waveguide 4b are greater than 240 nm.

What is claimed is:

1. An optical path routing element, comprising
a first optical waveguide; and
a second optical waveguide that is parallel to the first optical waveguide, wherein
the first optical waveguide and the second optical waveguide have a same thickness and a same width, and
said width is within a range based upon coupling lengths of the first and second waveguides for a TE polarization and for a TM polarization such that the difference between the coupling length for TE polarization and the coupling length for TM polarization is no more than a predetermined percentage of the sum of the coupling length for TE polarization and the coupling length for TM polarization divided by 2.

2. The optical path routing element in accordance with claim 1, wherein said width is larger than said thickness.

3. The optical path routing element in accordance with claim 1, wherein said range includes a value of said width such that said difference is equal to 0.

4. The optical path routing element in accordance with claim 3, wherein said width is smaller than said thickness.

5. The optical path routing element in accordance with claim 1, wherein a center interval between the center axes of the first optical waveguide and the second optical waveguide, and the widths and the thickness of the first and second optical waveguides are set so that the TE polarization in the antisymmetric mode is not cut off.

6. The optical path routing element in accordance with claim 1, further comprising:
a lower cladding and an upper cladding,
curved optical waveguides and input optical waveguides that are connected to the curved optical waveguides, and
output optical waveguides that are connected to the curved optical waveguides, wherein
the curved optical waveguides are connected to one side of the first optical waveguide and one side of the second optical waveguide,
a center interval between center axes of the input optical waveguides and a center interval between center axes of the output optical waveguides are set so as to eliminate the coupling of optical signals propagated through the input optical waveguides and the output optical waveguides, and
the first optical waveguide, the second optical waveguide, the input optical waveguides, the output optical waveguides, and the curved optical waveguides comprise a core that is folded by the upper and lower cladding.

7. The optical path routing element in accordance with claim 6, wherein opposite ends of the curved optical waveguides have different widths.

8. The optical path routing element in accordance with claim 1, wherein the predetermined percentage is less than 6%.
